(19) United States
(12) Patent Application Publication
(10) Pub. No.: US 2004/0264577 A1
(43) Pub. Date: Dec. 30, 2004

(54) Apparatus and method for controlling the synchronization of a video transport stream

(75) Inventor: Choon-sik Jung, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/874,548

(22) Filed: Jun. 24, 2004

(30) Foreign Application Priority Data
Jun. 24, 2003 (KR) 2003-41054

(51) Int. Cl. H04N 7/12

(52) U.S. Cl. 375/240.24; 375/240.16; 375/240.28; 375/240.25

(57) ABSTRACT

A system and method of decoding a video transport system, wherein the method controls the synchronization of a video transport stream and includes: comparing a frame feature value of a predetermined frame and a first threshold value; and transmitting a presentation skip command of the predetermined frame or a presentation repetition command of the predetermined frame according to the comparison result. As such, when an input rate of encoded video data is different from an output rate of the video data decoded by a display unit or when a system clock jitter occurs, natural pictures are displayed by skipping or repeating a frame for only consecutive frames that have little motion.

This application claims priority from Korean Patent Application No. 2003-41054, filed on Jun. 24, 2003, in the Korean Intellectual Property Office, the disclosure of which is incorporated herein in its entirety by reference.

### BACKGROUND OF THE INVENTION

1. Field of the Invention

The present invention relates to a system and method of decoding a video transport stream.

2. Description of the Related Art

FIG. 1 is a block diagram of a conventional system for decoding a video transport stream. With reference to FIG. 1, the conventional system for decoding a video transport stream includes an inverse multiplexer 11, a system time clock generator 12, a first comparator 13, a second comparator 14, a video decoder buffer 15, a video decoder 16, a frame buffer 17, and a video display unit 18.

The inverse multiplexer 11 receives a transport stream (TS), separates the received TS into multiple programs, and finally extracts a video synchronization parameter. The system time clock generator 12 generates a system time clock (STC) using a program clock reference (PCR), which is one of the video synchronization parameters. The first comparator 13 transmits a decoding control signal by comparing the STC and a decoding time stamp (DTS), which is another one of video synchronization parameters. The second comparator 14 transmits a presentation control signal by comparing the STC and a presentation time stamp (PTS), a video synchronization parameter. The video decoder buffer 15 stores video data. The video decoder 16 generates frame pictures by decoding data that was transmitted to and stored in the video decoder buffer 15. The frame buffer 17 stores the decoded frame data. The video display unit 18 displays the data stored in the frame buffer 17.

In the prior art, audio/video synchronization is performed by using a decoding time stamp and a presentation time stamp of the input video frames. Also, when the input rate of an encoded video data is different from the output rate of the video data decoded by the display unit or when a system clock jitter occurs, skipping or repeating of frames is performed during each fixed time interval for the synchronization of the video frames. Frames are skipped or repeated based only on a value that is the difference between the system time clock and the presentation time stamp, even though there may be consecutive frames with a lot of motion. However, all frames must be displayed during each fixed time interval in order to display natural pictures. Since some frames are skipped or are repeated in the prior art, regardless of motion, for more than the fixed time interval, unnatural pictures are displayed.

### SUMMARY OF THE INVENTION

An aspect of the present invention provides an apparatus and method to display natural pictures even when the input rate of an encoded video data is different from the output rate of the video data decoded by a display unit or when a system clock jitter occurs. Another aspect of the invention provides an apparatus and method for controlling the synchronization of a video transport stream used for the apparatus.

According to one aspect of the present invention, there is provided a method of controlling the synchronization of a video transport stream, the method comprising: comparing a frame feature value of a predetermined frame and a first threshold value; and transmitting a presentation skip command of the predetermined frame or a presentation repetition command of the predetermined frame according to the comparison result.

According to another aspect of the present invention, there is provided an apparatus for controlling the synchronization of a video transport stream, the apparatus comprising: a comparator comparing a frame feature value of a predetermined frame and a first threshold value; and a frame display controller transmitting a presentation skip command of the predetermined frame or a presentation repetition command of the predetermined frame according to the comparison result.

According to another aspect of the present invention, there is provided a method of decoding a video transport stream, the method comprising: receiving a presentation skip command of a predetermined frame determined on the basis of a first threshold value or a presentation repetition command of the predetermined frame; and decoding a video elementary stream according to the received presentation skip command or presentation repetition command.

According to another aspect of the present invention, there is provided a computer readable medium having recorded thereon a computer readable program for executing a method of controlling the synchronization of a video transport stream.

According to another aspect of the present invention, there is provided a computer readable medium having recorded thereon a computer readable program for executing a method of decoding a video transport stream.

### BRIEF DESCRIPTION OF THE DRAWINGS

The above and other features and advantages of the present invention will be readily apparent by describing in detail exemplary embodiments thereof with reference to the accompanying drawings, in which:

FIG. 1 is a block diagram of a conventional system for decoding a video transport stream;

FIG. 2 is a block diagram of a system for decoding a video transport stream according to an exemplary embodiment of the present invention;

FIG. 3 is a block diagram of an apparatus for controlling the synchronization of a video transport stream, according to an exemplary embodiment of the present invention;

FIG. 4 is a detailed block diagram of a frame display controller shown in FIG. 3;

FIG. 5 is a flowchart of a method for decoding a video transport stream, according to an exemplary embodiment of the present invention;

FIGS. 6A and 6B are flowcharts of a method for controlling the synchronization of a video transport stream, according to an exemplary embodiment of the present invention; and

FIG. 7 is a detailed flowchart of step 616 shown in FIG. 6.

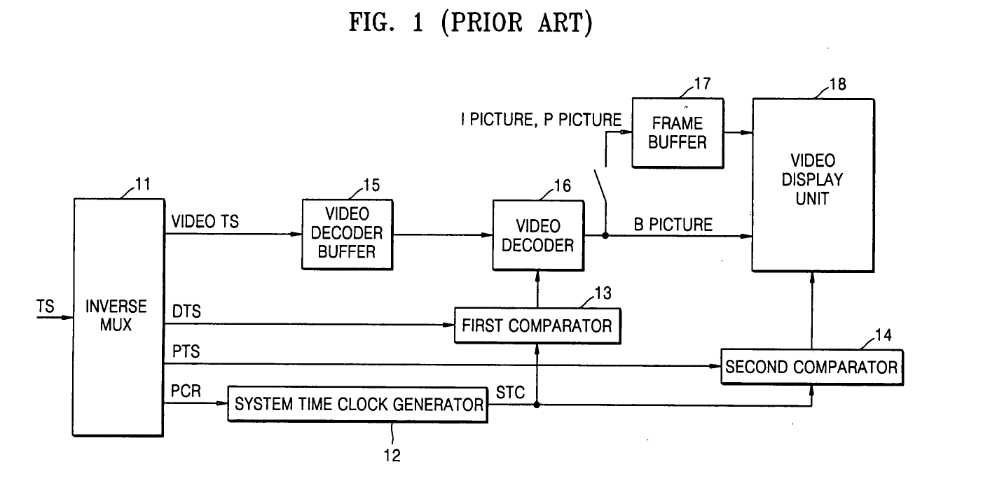

### DETAILED DESCRIPTION OF ILLUSTRATIVE, NON-LIMITING EMBODIMENTS OF THE INVENTION

The present invention will now be described more fully with reference to the accompanying drawings, in which illustrative, non-limiting embodiments of the invention are shown.

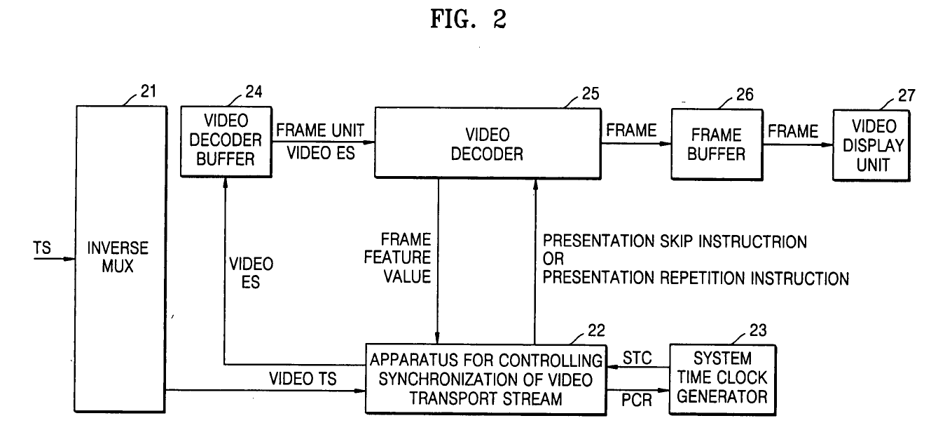

FIG. 2 is a block diagram of a system for decoding a video transport stream according to an exemplary embodiment of the present invention. With reference to FIG. 2, the system for decoding a video transport stream includes an inverse multiplexer 21, an apparatus for controlling the synchronization of a video transport stream 22, an STC generator 23, a video decoder buffer 24, a video decoder 25, a frame buffer 26, and a video display unit 27.

The inverse multiplexer 21 receives a TS including a data stream for a predetermined frame, separates a video transport stream from the received TS, and finally extracts the separated video TS. According to the Motion Picture Experts Group (MPEG) 2 standard, a data stream includes a program stream (PS) composed of one program and a TS composed of multiple programs. A TS multiplexes a packetized elementary stream (PES) of video data and audio data. An encoding system inserts identification information of the respective programs and the synchronization time information with a decoding system into a PES before the PES is multiplexed as a TS. According to the MPEG 2 standard, the identification information of the respective programs is called a packet identifier (PID), which has a unique integer value for every elementary stream (ES) of a program. The inverse multiplexer 21 separates only a video TS from a TS using the PID included in the PES.

Also, the apparatus for controlling the synchronization of a video transport stream 22 extracts a reference clock of an encoding system from the received video TS and then transmits the extracted reference clock of the encoding system. According to the MPEG 2 standard, the reference clock of the encoding system is a program clock reference (PCR) that is necessary for setting the clock of a decoding system to the value of an encoding system.

The system time clock generator 23 receives a reference clock of the encoding system transmitted from the apparatus for controlling the synchronization of a video transport stream 22 and then generates an STC by synchronizing the clock of system for decoding a video transport system on the basis of the received reference clock of the encoding system.

The apparatus for controlling the synchronization of a video transport stream 22 receives a video TS transmitted from the inverse multiplexer 21 and then extracts a PTS, which is a reference time for displaying a frame, and a video ES, which is an encoding value for a frame from the received video TS. The PTS is a kind of synchronization time information, with a decoding system and time management information in a frame, display procedure. The ES is one of an encoding video, an encoding audio, and another kind of encoding bit stream. In the case of a video signal, the time required for encoding and decoding is very long in comparison to an audio signal. Therefore, video and audio signals frequently do not match in a decoding system. This is called a lip sync discordance phenomenon, and in order to solve this problem, PTS information designating the time for displaying a video signal and an audio signal after they are decoded is needed. A decoding system displays a frame when a PTS is matched to an STC generated from the STC generator 23. A DTS is necessary for synchronization of time information with a decoding system because, in MPEG, the output order of an encoding bit stream of video is special. That is, because an I picture and a P picture are transmitted prior to a B picture, the decoding order may be different from the displaying order. Therefore when the PTS is different from the DTS, both of them are transmitted consecutively, and when the PTS is same as the DTS, only the DTS is transmitted.

Also, the apparatus for controlling the synchronization of a video transport stream 22 compares a frame feature value, which is a feature value for the frame, and a first threshold value, which is a threshold value of the frame feature value used for the presentation skip and the presentation repetition for the frame; and, if the frame feature value is smaller than the first threshold value, transmits a presentation skip command or a presentation repetition command for the frame according to a presentation time difference value obtained by subtracting the PTS from the STC, which is a clock synchronized on the basis of a reference clock of an encoding system which encodes a frame. An example of a feature value is a motion magnitude value of a frame determined on the basis of another frame just prior to the current frame. This motion magnitude value may be a sum of the motion vectors of the macro blocks of the frame, the number of intra coding macro blocks of the frame, or a sum of the sum of the motion vectors of the macro blocks of the frame and the number of intra coding macro blocks of the frame. As a motion vector is a value displaying the magnitude and direction of the motion of the same object in the corresponding macro blocks between two frames, a sum of the motion vectors for the macro blocks of the frame may be a measure of the motion between frames. In contrast to inter coding, which encodes only the changed parts of the corresponding macro blocks between two frames by using a motion vector and others, intra coding is a decoding method performed in the case where encoding and decoding of the entire macro blocks is effective because the motion of the corresponding macro blocks between two frames is very big. Therefore, the number of intra coding macro blocks of a frame may be a measure of the motion between frames. A sum of the sum of the motion vectors of the macro blocks of a frame and the number of intra coding macro blocks of the frame may present more accurate information on the magnitude of the motion between frames.

A first threshold value is a threshold value of a frame feature value for the presentation skip and presentation repetition for a frame, and this value is determined by a method for defining a frame feature value. In general, because a sum of the motion vectors of the macro blocks of a frame is larger than the number of intra coding macro blocks of the frame, the magnitude of a first threshold value may have to be set larger in the case where a sum of the motion vectors of the macro blocks of a frame is used as the frame feature value than in the case where the number of intra coding macro blocks of a frame is used as the frame feature value. In the case where the sum of both is used as the frame feature value, the magnitude of a first threshold value may have to be set even larger.

If a frame feature value is not smaller than a first threshold value because the motion of a corresponding frame is larger than that of a previous frame, then skipping a corresponding frame or repeating a corresponding frame will cause unnatural pictures to be displayed. Therefore, if a frame feature value is not smaller than a first threshold value, natural pictures may be displayed by omitting the presentation skip and the presentation repetition for a corresponding frame. A decoding system designer may have to set a first threshold value with a proper value while considering the method for defining a frame feature value, a feature of display unit and others. If a frame feature value is smaller than a first threshold value, then the presentation skip or the presentation repetition for a corresponding frame is performed.

The following describes in more detail a case where a presentation skip command is transmitted, and a case where a presentation repetition command is transmitted. If a frame feature value is smaller than a first threshold value, the apparatus for controlling the synchronization of a video transport stream 22 calculates a presentation time difference value by subtracting the PTS from the STC. When the PTS and the STC match each other, that is, when a presentation time difference value is 0, a corresponding frame is displayed.

Also, the apparatus for controlling the synchronization of a video transport stream 22 compares the calculated presentation time difference value with a second threshold value, which is a threshold value of the presentation time difference value used for the presentation skip and the presentation repetition for a frame; and if the presentation time difference value is larger than the second threshold value, transmits a presentation skip command for a frame, and if the presentation time difference value is smaller than a negative quantity of the second threshold value, transmits a presentation repetition command for a frame. A second threshold value is determined according to the accuracy of the video synchronization. That is, because synchronization must be performed more precisely in the case where the accuracy of the video synchronization is high, the second threshold value must be set smaller than in the case where the accuracy of video synchronization is low.

Because an audio is replayed prior to a video in the case where a presentation time difference value is larger than a second threshold value, a new frame may be displayed quickly by transmitting a presentation skip command for a frame. Because a video is replayed prior to an audio in the case where a presentation time difference value is smaller than a negative quantity of the second threshold value, displaying a new frame may be delayed by transmitting a presentation repetition command for a frame.

The video decoder 25 decodes a video ES according to a presentation skip command or a presentation repetition command transmitted from the apparatus for controlling the synchronization of a video transport stream 22. That is, the video decoder 25 receives a presentation skip command or a presentation repetition command transmitted from the apparatus for controlling the synchronization of a video transport stream 22, and then skips decoding for a frame, in the case of receiving a presentation skip command, or repeats decoding for a frame, in the case of receiving a presentation repetition command. Because, in the case of receiving a presentation skip command, a corresponding frame does not have to be displayed (an audio is replayed prior to a video), the presentation time difference value is reduced by directly decoding the video ES for a new frame without decoding the video ES for a corresponding frame. Because, in the case of receiving a presentation repetition command, a corresponding frame is displayed continuously (a video is replayed prior to an audio), the corresponding frame is decoded and the status of the corresponding frame is maintained, without decoding the video ES for a new frame, until the presentation time difference value is not smaller than a negative quantity of the second threshold value.

The apparatus for controlling the synchronization of a video transport stream 22 transmits the extracted video ES, and the video decoder buffer 24 stores the video ES transmitted from the apparatus for controlling the synchronization of a video transport stream 22. The video decoder buffer 24 stores the video ES in advance for smoothly decoding in the video decoder 25. The video decoder 25 reads and decodes the video ES from the video decoder buffer 24 whenever it is necessary.

The video decoder 25 decodes the video ES stored in the video decoder buffer 24 into a frame, extracts a frame feature value from the decoded frame, and finally transmits the extracted frame feature value. The apparatus for controlling the synchronization of a video transport stream 22 compares the frame feature value transmitted from the video decoder 25 with a first threshold value. The frame buffer 26 stores the frame decoded in the video decoder 25. The video display unit 27 displays the frame stored in the frame buffer 26.

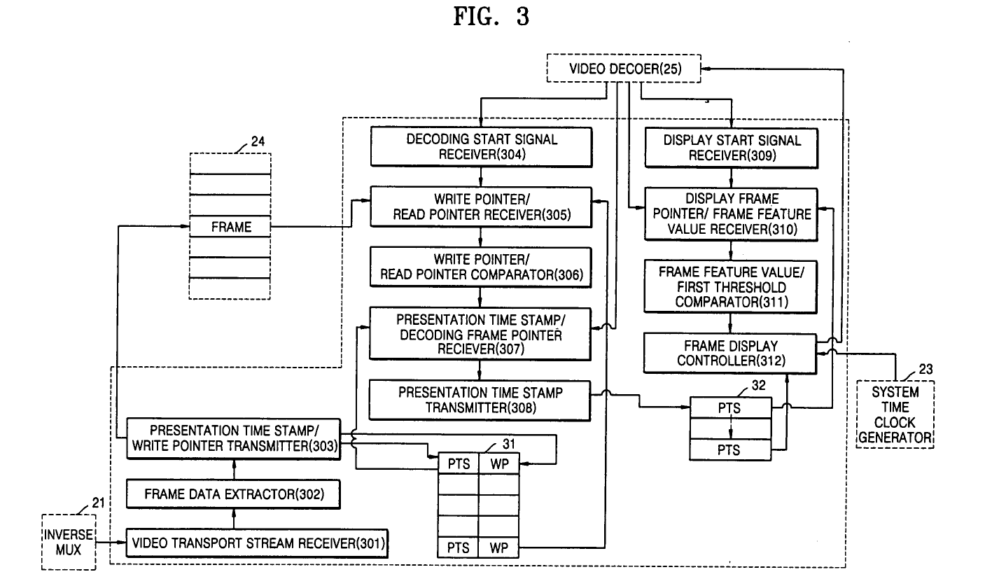

FIG. 3 is a block diagram of the apparatus for controlling the synchronization of a video transport stream 22 according to an exemplary embodiment of the present invention.

With reference to FIG. 3, the apparatus for controlling the synchronization of a video transport stream 22 includes a video TS receiver 301, a frame data extractor 302, a PTS/write pointer transmitter 303, a decoding start signal receiver 304, a write pointer/read pointer receiver 305, a write pointer/read pointer comparator 306, a PTS/decoding frame pointer receiver 307, a PTS transmitter 308, a display start signal receiver 309, a display frame pointer/frame feature value receiver 310, a frame feature value/first threshold value comparator 311, a frame display controller 312, a PTS buffer 31, and a PTS register 32.

The video TS receiver 301 receives a video TS from the inverse multiplexer 21, which separates the video TS from a TS. The frame data extractor 302 extracts a PTS and a video ES, which is a decoding value for a frame from a video TS received by the video TS receiver 301.

The PTS/write pointer transmitter 303 transmits the PTS extracted from the frame data extractor 302 to a first memory location of the PTS buffer 31, transmits the video ES extracted from the frame data extractor 302 to a first memory location of the video decoder buffer 24, and transmits a write pointer which indicates the address of the first memory location of the video decoder buffer 24 to a second memory location of the PTS buffer 31 to correspond to the first memory location of the PTS buffer 31. In general, a decoder in a decoding system includes a buffer. The buffer has a role of preventing an underflow or an overflow of the data to be decoded when the decoder decodes data. For MPEG 2, because this standard is applied to TV broadcasting and wired/wireless communications with wide fields, the transmission rate of TS varies. Therefore, the buffer is used for compensating the variable transmission rate. For preventing an underflow or an overflow of the data to be decoded, the present invention includes a write pointer indicating an address written to in the video decoder buffer 24 and a read pointer indicating an address to be read from in the video decoder buffer 24. Frames are written in the video decoder buffer 24 according to an input order and are read according to the order in which they are written. Therefore, if a write pointer indicates a lower address than that of a read pointer, an underflow or an overflow of data to be decoded can be dealt with. The PTS buffer 31 is a buffer which temporarily stores a PTS for a certain frame and a write pointer indicating an address of the place in which the frame is stored. The PTS buffer 31 stores a write pointer to be compared with a read pointer and stores a PTS corresponding to the read pointer.

The decoding start signal receiver 304 receives a decoding start signal, which is a signal informing the start of a decoding for a certain frame from the video decoder 25. In general, the decoding start signal, in the case where the decoder is decoding a previous frame, is sent as an interrupt signal to inform that the decoding of the next frame has started.

If a decoding start signal is received by the decoding start signal receiver 304, the write pointer/read pointer receiver 305 receives a write pointer indicating the address of the second memory location of the video decoder buffer 24 from a third memory location of the PTS buffer 31, and receives the read pointer indicating the address of the first memory location of the video decoder buffer 24, which is the read memory location at the time when the decoding start signal is received from the video decoder buffer 24. That is, if the decoding start signal is received by the decoding start signal receiver 304, the write pointer/read pointer receiver 305 receives the write pointer indicating the address of the frame stored in the PTS buffer 31 and the read pointer indicating the address of the location to be read from the PTS buffer 31.

The write pointer/read pointer comparator 306 compares the write pointer with the read pointer received by the write pointer/read pointer receiver 305.

When the write pointer indicates a lower address than that of the read pointer as the comparison result in the write pointer/read pointer comparator 306, the PTS/decoding frame pointer receiver 307 receives the PTS from the first memory location of the PTS buffer 31 in which the PTS transmitted from the PTS/write pointer transmitter 303 is written. At this time, the received PTS is a PTS of a frame which has to be decoded in consideration of a data transmission rate. Also, the PTS/decoding frame pointer receiver 307 receives a decoding frame pointer indicating the address of the first memory location of the PTS register 32 from the video decoder 25. The PTS register 32 stores the PTS of the frame to be decoded and the PTS of the frame to be displayed in order to control the output of the video decoder 25 and the input of the display unit so that the decoding procedure and the display procedure are performed smoothly. Also, the PTS register 32 rearranges the order of the frames according to an I picture, a P picture, and a B picture. A pointer indicating the address of the memory location of the PTS register 32 includes a decoding frame pointer and a display frame pointer. The decoding frame pointer indicates an address of a memory location of a frame to be decoded and the display frame pointer indicates an address of a memory location of a frame to be displayed.

The PTS transmitter 308 transmits the PTS received from the PTS/decoding frame pointer receiver 307 to the first memory location of the PTS register 32 indicated by the decoding frame pointer received from the PTS/decoding frame pointer receiver 307. The PTS register 32 receives the transmitted PTS and then stores the received PTS in the first memory location indicated by the decoding frame pointer.

The display start signal receiver 309 receives the display start signal informing the start of display for a frame from the video decoder 25.

If a display start signal is received by the display start signal receiver 309, the display frame pointer/frame feature value receiver 310 receives the display frame pointer indicating the address of a first memory location of the PTS register 32 from the video decoder 25 and receives the frame feature value for the frame having a PTS stored in the first memory location of the PTS register 32 indicated by the display frame pointer received from the video decoder 25. With reference to FIG. 3, the PTS register 32 has three memory locations where a decoding frame pointer indicates an upper memory location and a display frame pointer indicates a lower memory location. In the case of displaying after decoding a certain frame, the PTS of the displayed frame is deleted and the PTS of a frame which has not yet been decoded is newly stored. Therefore, the PTS of a certain frame stored in the first memory location of the PTS register 32 is changed from a decoding object to a display object according to the decoding and display processing of another frame. Also, with reference to FIG. 3, in order to perform a decoding procedure and a display procedure by a wide margin, a corresponding frame is displayed by using a PTS stored in an address indicated by a display frame pointer if there is a three frame difference between the decoding frame pointer and the display frame pointer. According to the above description, both the decoding frame pointer and the display frame pointer indicate a first memory location, but for describing the decoding process and the displaying process, they are illustrated as indicating separate memory locations. That is, in the decoding process, the upper location is the first memory location and the lower location is another memory location, but in the displaying process, the lower location is the first memory location and the upper location is another memory location.

The frame feature value/first threshold value comparator 311 compares a frame feature value, which is a feature value for a frame received in the display frame pointer/frame feature value receiver 310, with a first threshold value, which is a threshold value of the frame feature value for the presentation skip and the presentation repetition for a frame. As described above, an example of a feature value is a motion magnitude value of a certain frame determined on the basis of another frame just prior to the current frame. The motion magnitude value may be a sum of the motion vectors of the macro blocks of a frame, the number of intra coding macro blocks of the frame, or a sum of the sum of the motion vectors of the macro blocks of the frame and the number of intra coding macro blocks of the frame.

A first threshold value is a threshold value of a frame feature value for the presentation skip and the presentation repetition for a frame. This value is determined by a method for defining the frame feature value. In general, because a sum of the motion vectors of the macro blocks of a frame is larger than the number of intra coding macro blocks of the frame, the magnitude of a first threshold value may have to be set larger in the case where the frame feature value is the sum of the motion vectors of the macro blocks of a frame than in the case where the frame feature value is the number of intra coding macro blocks of a frame. In the case where the frame feature value is a sum of the number of intra coding macro blocks of the frame and the sum of the motion vectors of the macro blocks of the frame, the magnitude of the first threshold value may have to be set even larger.

The frame display controller 312 receives the PTS stored in the first memory location of the PTS register 32 indicated by the display frame pointer received by the display frame pointer/frame feature value receiver 310. At this time, the PTS is a PTS of a frame to be displayed. Also, if the frame feature value is smaller than the first threshold value, the frame display controller 312 transmits a presentation skip command for a frame or a presentation repetition command for a frame according to a presentation time difference value obtained by subtracting a PTS from an STC, which is a clock synchronized on the basis of a reference clock of an encoding system which encodes a frame.

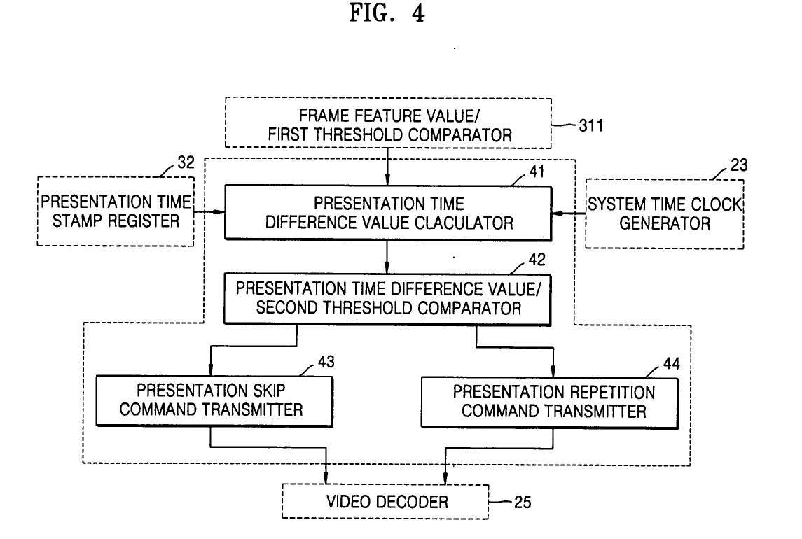

FIG. 4 is a detailed block diagram of the frame display controller 312 shown in FIG. 3. With reference to FIG. 4, the frame display controller 312 includes a presentation time difference value calculator 41, a presentation time difference value/second threshold value comparator 42, a frame presentation skip command transmitter 43, and a frame presentation repetition command transmitter 44.

Based on a comparison result in the frame feature value/first threshold value comparator 311, if the frame feature value is smaller than the first threshold value, the presentation time difference value calculator 41 calculates a presentation time difference value by subtracting the PTS from the STC. If the frame feature value is not smaller than the first threshold value because the motion of a corresponding frame is larger than that of the immediately preceding frame, then skipping a corresponding frame or repeating a corresponding frame will cause unnatural pictures to be displayed. Therefore, if the frame feature value is not smaller than the first threshold value, natural pictures may be displayed by omitting the presentation skip and the presentation repetition for a corresponding frame. A decoding system designer may have to set a first threshold value to a proper value while considering the method for defining a frame feature value, a feature of display unit and others. If a frame feature value is smaller than a first threshold value, then the presentation skip or the presentation repetition for a corresponding frame is performed.

The presentation time difference value/second threshold value comparator 42 compares the presentation time difference value calculated in the presentation time difference value calculator 41 with a second threshold value which is a threshold value of the presentation time difference value for the presentation skip and the presentation repetition for a frame. The second threshold value is determined according to the accuracy of the video synchronization. That is, because synchronization must be performed more precisely when the accuracy of video synchronization is high, the second threshold value must be set smaller than when the accuracy of the video synchronization is low.

Based on a comparison result by the presentation time difference value/second threshold value comparator 42, if the presentation time difference value is larger than the second threshold value, the frame presentation skip command transmitter 43 transmits a presentation skip command for a frame. Because an audio is replayed prior to a video when the presentation time difference value is larger than the second threshold value, a new frame may be displayed quickly by transmitting the presentation skip command for the frame.

Based on a comparison result by the presentation time difference value/second threshold value comparator 42, if the presentation time difference value is smaller than a negative quantity of second threshold value, the frame presentation repetition command transmitter 44 transmits a presentation repetition command for a frame. Because a video is replayed prior to an audio when the presentation time difference value is smaller than the negative quantity of the second threshold value, displaying a new frame may be delayed by transmitting the presentation repetition command for the frame.

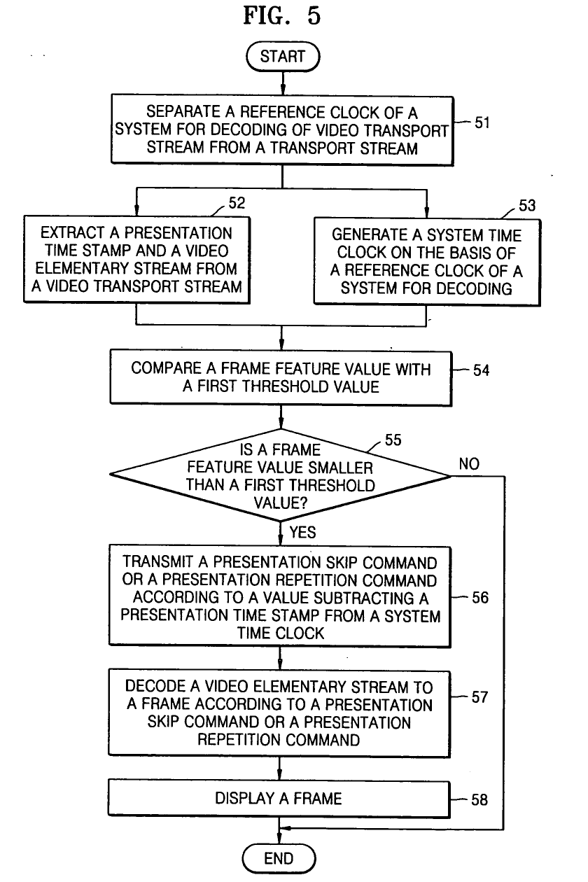

FIG. 5 is a flowchart of a method for decoding a video transport stream according to an exemplary embodiment of the present invention. With reference to FIG. 5, the method for decoding a video transport stream includes the following.

In step 51, a TS including a data stream for a predetermined frame is received, a video TS is separated from the received TS, and finally, the separated video TS is transmitted. In step 52, the transmitted video TS is received, a PTS, which is a reference time displaying the frame, and a video ES, which is an encoding value for the frame, are extracted from the received video TS. In step 53, a reference clock of an encoding system is extracted from the received video TS, the extracted reference clock of the encoding system is transmitted, the transmitted reference clock of the encoding system is received, and finally, an STC is generated by synchronizing a clock of a system of decoding a video transport system based on the received reference clock of the encoding system.

Thereafter, in step 54, a frame feature value, which is a feature value for the frame, is compared with a first threshold value, which is a threshold value of a frame feature value for the presentation skip and the presentation repetition for the frame. Next, if the frame feature value is smaller than the first threshold value in step 55, a presentation skip command or a presentation repetition command for the frame is transmitted in step 56 according to a presentation time difference value obtained by subtracting the PTS from the STC, which is a synchronized clock based on a reference clock of an encoding system which encodes the frame. In more detail, if the frame feature value is smaller than the first threshold value, the presentation time difference value is calculated by subtracting the PTS from the STC. The calculated presentation time difference value is then compared with the second threshold value which is the threshold value of a presentation time difference value for the presentation skip and the presentation repetition for the frame. Finally, if the presentation time difference value is larger than the second threshold value, a presentation skip command for the frame is transmitted. If the presentation time difference value is smaller than the negative quantity of the second threshold value, a presentation repetition command for the frame is transmitted. The feature value is a motion magnitude value of the frame determined on the basis of a frame immediately prior to the current frame. The motion magnitude value is a sum of the motion vectors of the macro blocks of the frame, the number of intra coding macro blocks of the frame, or a sum of the sum of the motion vectors of the macro blocks of the frame and the number of intra coding macro blocks of the frame.

Next, in step 57, a video ES is decoded according to the transmitted presentation skip command or a presentation repetition command. Thus, when a presentation skip command is received, the decoding of the frame is skipped, and when a presentation repetition command is received, the decoding of the frame is repeated.

An additional step that stores the video extracted in step 52 may be inserted prior to step 54 in order to ensure the decoding is performed smoothly.

Also, an additional step which stores the decoded frame from step 57 may be inserted in order to ensure the displaying is performed smoothly when the video ES stored in step 54 is decoded to the frame, a frame feature value is extracted from the decoded frame, the extracted frame feature value is transmitted, and finally, the transmitted frame feature value is compared with a first threshold value in step 55. Next, the stored frame is displayed in step 58.

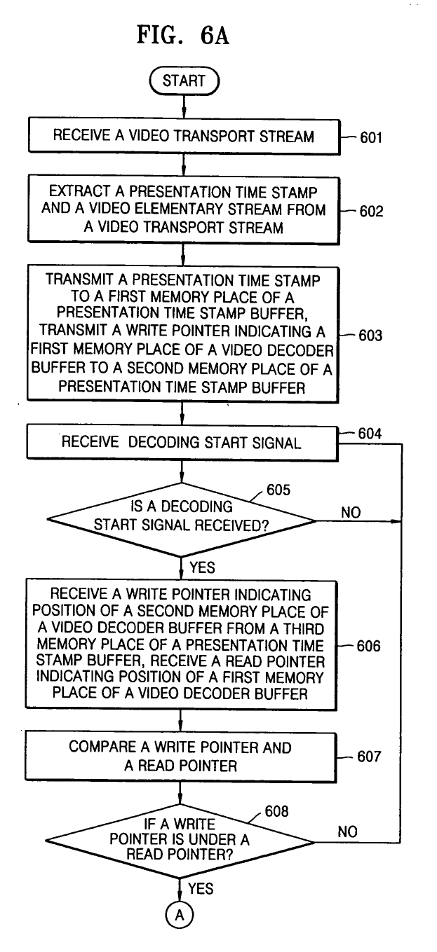

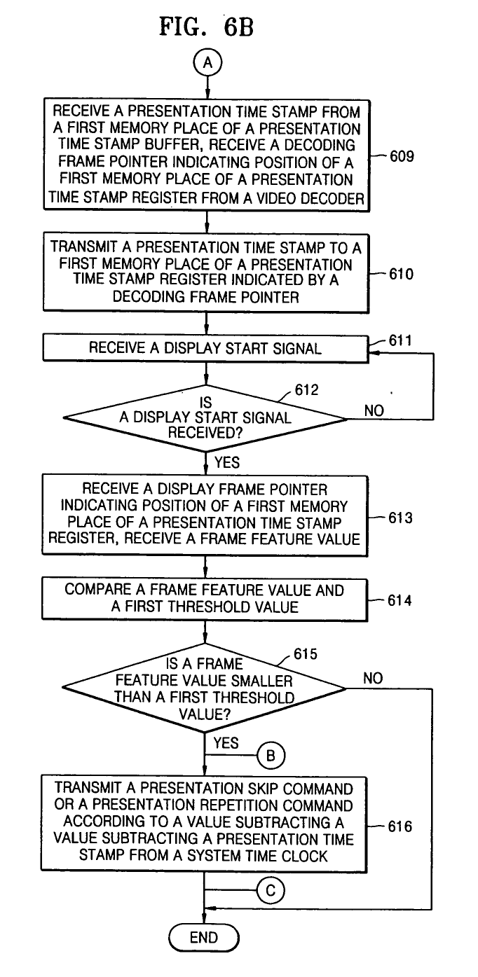

FIGS. 6a and 6b are flowcharts of a method for controlling the synchronization of a video TS according to an exemplary embodiment of the present invention. With reference to FIGS. 6a and 6b, a method for controlling the synchronization of a video TS includes the following.

In step 601, a video TS is received from an inverse multiplexer 21, which separates a video TS from a TS. Thereafter, a PTS, which is a reference time for displaying a frame, and a video ES, which is a decoding value for the frame from the received video TS, are extracted in step 602. In step 603, the extracted PTS is transmitted to a first memory location of the PTS buffer 31, the extracted video ES is transmitted to a first memory location of the video decoder buffer 24, and a write pointer, which indicates the address of the first memory location of the video decoder buffer 24, is transmitted to a second memory location of the PTS buffer 31 to correspond to the first memory location of the PTS buffer 31.

After this, a decoding start signal, which is a signal informing the start of the decoding of a frame, is received in step 604 from the video decoder 25. After the decoding start signal has been received in step 605, a write pointer indicating the address of the second memory location of the video decoder buffer 24 is received from a third memory location of the PTS buffer 31, and a read pointer indicating the address of the first memory location of a video decoder buffer 24, which is a read memory location of the time when the decoding start signal is received, is received from the video decoder buffer 24 in step 606. Then, the received write pointer and the read pointer are compared in step 607. If the write pointer indicates a lower address than that of the read pointer in step 608, the PTS is received from the first memory location of the PTS buffer 31 in which the transmitted PTS is written and the decoding frame pointer indicating the address of the first memory location of the PTS register 32 is received from the video decoder 25 in step 609. Then, the received PTS is transmitted in step 610 to the first memory location of the PTS register 32 indicated by the received decoding frame pointer. In step 611, a display start signal indicating the start of the display for the frame is received from the video decoder 25. After the display start signal is received in step 612, a display frame pointer indicating the address of the first memory location of the PTS register 32 is received from the video decoder 25 and the frame feature value for a frame having the PTS stored in the first memory location of the PTS register 32 indicated by the received display frame pointer is received from the video decoder 25 in step 613. A feature value is a motion magnitude value of a certain frame determined on the basis of a frame immediately prior to the frame, and a motion magnitude value is a sum of the motion vectors of the macro blocks of the frame, the number of intra coding macro blocks of the frame, or a sum of the sum of the motion vectors of the macro blocks of the frame and the number of intra coding macro blocks of the frame.

Thereafter, in step 614, the received frame feature value is compared with a first threshold value, which is a threshold value of a frame feature value for the presentation skip and the presentation repetition for the frame. If the frame feature value is smaller than the first threshold value in step 615, then, in step 616, a PTS stored in the first memory location of the PTS register 32 indicated by the received display frame pointer is received and a presentation skip command for the frame or a presentation repetition command for the frame is transmitted according to a presentation time difference value obtained by subtracting the received PTS from an STC, which is a clock synchronized on the basis of a reference clock of an encoding system which encodes the frame.

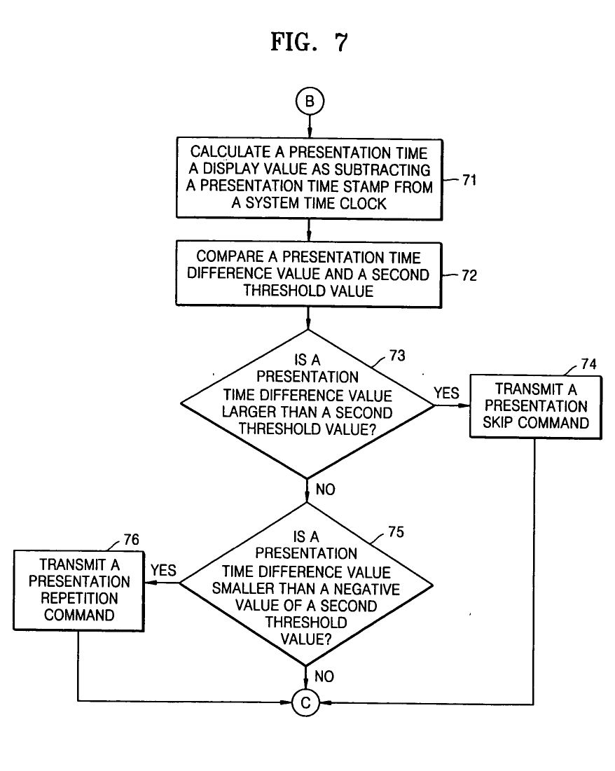

FIG. 7 is a detailed flowchart of the step 616 shown in FIG. 6.

With reference to FIG. 7, step 616 includes the following.

If the frame feature value is smaller than the first threshold value, a presentation time difference value is calculated by subtracting the PTS from the STC in step 71. Then, in step 72, the calculated presentation time difference value is compared with a second threshold value, which is a threshold value of a presentation time difference value for the presentation skip and the presentation repetition for the frame. If the presentation time difference value is larger than the second threshold value in step 73, a presentation skip command for the frame is transmitted in step 74. If the presentation time difference value is smaller than a negative quantity of the second threshold value in step 75, a presentation repetition command for the frame is transmitted in step 76.

An apparatus consistent with the present invention may be embodied in a general-purpose computer by running a program from a computer readable medium, including but not limited to a storage media such as magnetic storage media (ROMs, RAMs, floppy disks, magnetic tapes, etc.), an optically readable media (CD-ROMs, DVDs, etc.), and carrier waves (transmission over the internet).

According to the present invention, when an input rate of encoded video data is different from an output rate of video data decoded by a display unit or when a system clock jitter occurs, natural pictures are displayed by skipping or repeating a frame for consecutive frames that have little motion. Also, according to the present invention, by using a PTS buffer for decoding, an overflow/underflow of a decoder buffer is prevented. Also, according to the present invention, by controlling an output of a decoder and an input of a display unit by using a PTS register, a decoding procedure and a display procedure are performed smoothly and the order of the frames is rearranged according to an I picture, a P picture, and a B picture.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for controlling a synchronization of a video transport stream, comprising:
comparing a feature value of a predetermined frame and a first threshold value; and
transmitting a presentation skip command of the predetermined frame or a presentation repetition command of the predetermined frame according to the comparison result.

2. The method of claim 1, wherein the feature value is a motion magnitude value of the predetermined frame determined on the basis of an immediately preceding frame to the predetermined frame.

3. The method of claim 2, wherein the motion magnitude value is a sum of motion vectors of macro blocks of the predetermined frame, the number of intra coded macro blocks of the predetermined frame, or a sum of the sum of motion vectors of macro blocks of the predetermined frame and the number of intra coded macro blocks of the predetermined frame.

4. The method of claim 1, wherein the transmitting comprises:
if the frame feature value is smaller than the first threshold value, transmitting the presentation skip command of the predetermined frame or the presentation repetition command of the predetermined frame according to a presentation time difference value calculated by subtracting a presentation time stamp (PTS) from a system time clock (STC).

5. The method of claim 4, wherein the transmitting comprises:
if the presentation time difference value is larger than a second threshold value, transmitting the presentation skip command of the predetermined frame; and
if the presentation time difference value is smaller than the negative quantity of the second threshold value, transmitting the presentation repetition command of the predetermined frame.

6. An apparatus for controlling synchronization of a video transport stream, the apparatus comprising:
a comparator comparing a frame feature value of a predetermined frame and a first threshold value; and
a frame display controller transmitting a presentation skip command of the predetermined frame or a presentation repetition command of the predetermined frame according to the comparison result.

7. The apparatus of claim 6, wherein the feature value is a motion magnitude value of the predetermined frame determined on the basis of an immediately preceding frame to the predetermined frame.

8. The apparatus of claim 7, wherein the motion magnitude value is a sum of motion vectors of macro blocks of the predetermined frame, the number of intra coded macro blocks of the predetermined frame, or a sum of the sum of motion vectors of macro blocks of the predetermined frame and the number of intra coded macro blocks of the predetermined frame.

9. The apparatus of claim 6, wherein the frame display controller, if the frame feature value is smaller than the first threshold value, transmits the presentation skip command of the predetermined frame or the presentation repetition command of the predetermined frame according to a presentation time difference value calculated by subtracting a presentation time stamp (PTS) from a system time clock (STC).

10. The apparatus of claim 9, wherein the frame display controller comprises:
a frame presentation skip command transmitter transmitting the presentation skip command of the predetermined frame if the presentation time difference value is larger than the second threshold value; and
a frame presentation repetition command transmitter transmitting the presentation repetition command of the predetermined frame if the presentation time difference value is smaller than the negative quantity of the second threshold value.

11. A method for decoding a video transport stream, comprising:
receiving, on the basis of a first threshold value, a presentation skip command of a predetermined frame or a presentation repetition command of the predetermined frame; and
decoding a video elementary stream according to the received presentation skip command or the received presentation repetition command.

12. The method of claim 11, wherein the receiving comprises:
if a feature value is smaller than the first threshold value, receiving the presentation skip command or the presentation repetition command determined by a presentation time difference value calculated by subtracting a presentation time stamp (PTS) from a system time clock (STC).

13. The method of claim 12, wherein the feature value is a motion magnitude value of the predetermined frame determined on the basis of an immediately preceding frame to the predetermined frame.

14. The method of claim 12, wherein the receiving comprises:
if the presentation time difference value is larger than a second threshold value, receiving the presentation skip command of the predetermined frame; and
if the presentation time difference value is smaller than the negative quantity of the second threshold value, receiving the presentation repetition command of the predetermined frame.

15. The method of claim 11, wherein the decoding the video elementary stream comprises:
skipping decoding of the predetermined frame when the presentation skip command is received; and
repeating decoding of the predetermined frame when the presentation repetition command is received.

16. A computer readable medium having recorded thereon a computer readable program for executing a method of controlling a synchronization of a video transport stream, the method comprising:
comparing a feature value of a predetermined frame and a first threshold value; and
transmitting a presentation skip command of the predetermined frame or a presentation repetition command of the predetermined frame according to the comparison result.

17. A computer readable medium having recorded thereon a computer readable program for executing a method of decoding a video transport stream, the method comprising:
receiving, on the basis of a first threshold value, a presentation skip command of a predetermined frame or a presentation repetition command of the predetermined frame; and
decoding a video elementary stream according to the received presentation skip command or the received presentation repetition command.
